(19) United States
(12) Patent Application Publication
(10) Pub. No.: US 2017/0266918 A1
(43) Pub. Date: Sep. 21, 2017

(54) Selectively Repositionable Absorbent Mat with Releasably Adhering V-Fold

(71) Applicant: The Bramton Company, LLC, Irving, TX (US)

(72) Inventors: Scott Alan Plasek, Flower Mound, TX (US); Robert C. Pearce, III, Arlington, TX (US); Alisha Farrington, Bedford, TX (US); Alexander C. Erdman, Irving, TX (US); Katrell Deon Copeland, McKinney, TX (US); Craig Cain, Irving, TX (US)

(21) Appl. No.: 15/070,714

(22) Filed: Mar. 15, 2016

(51) Int. Cl. B32B 7/14; B32B 27/08; B32B 27/32; B32B 7/12

(52) U.S. Cl. CPC B32B 7/14; B32B 7/12; B32B 27/08; B32B 27/32; B32B 2307/726; B32B 2307/3065

(57) ABSTRACT

A selectively repositionable mat having a liquid-absorbing layer backed by a moisture impermeable backsheet having peripheral margins including oppositely disposed, laterally extending side margins each comprising a longitudinally extending V-fold containing a pressure-sensitive adhesive applied between two opposed surface portions of the underside of the backsheet. The V-fold can open to the outside when configured as the top part of a Z-fold disposed above the backsheet or can open to the inside when configured as a single fold disposed below the backsheet, but is desirably configured so as to permit repositionable attachment of the mat to an underlying surface or substrate for which the selectively releasable, pressure-sensitive adhesive demonstrates sufficient tackiness to hold the mat in place relative to the substrate during normal use.

### FIELD OF THE INVENTION

This invention relates to absorbent mats that can be releasably secured to an underlying substrate and are also selectively repositionable for the same or a different subsequent use. The subject mats or pads are suitable for use as waste-absorbing or capillary action mats for animals, or as incontinence pads (for beds, chairs, couches, etc.) for human use, or as temporary coverings for floors or other support surfaces (painters' mats, arts and crafts spill-protection mats, mechanics' drip mats, vehicle floorboard mats, etc.) or for other similar uses. Other possible uses include placemats, plant mats, mats placed under children's booster seats and car seats, under-sink mats, plumbing mats, pet food dish mats, welding heat shields, toilet seat covers, potty training pads, diaper changing pads, mattress pads, cargo mats, and the like.

More particularly, one aspect of this invention relates to a selectively repositionable mat that comprises a pressure-sensitive adhesive applied so as to achieve releasable engagement between two opposed sides of a V-fold. The two sides of the V-fold are desirably brought into facing engagement with each other following application of a selectively releasable, pressure-sensitive adhesive between them, and mats comprising the releasably engaged V-folds can be packaged, shipped, stored and displayed without the need for a removable release strip or paper to cover the applied adhesive prior to use. A V-fold of the subject mat can open to the outside (if configured as the top part of a Z-fold disposed above the web or backsheet) or can open to the inside (if configured as a single fold disposed below the backsheet), but is desirably configured so as to permit repositionable attachment of the mat or pad to an underlying surface or substrate for which the selectively releasable, pressure-sensitive adhesive demonstrates sufficient tackiness to hold the pad backsheet in place relative to the substrate during normal use.

### DESCRIPTION OF RELATED ART

Moisture-absorbing pads have previously been disclosed, for example, in U.S. Pat. Nos. 5,630,376; 7,249,570; 8,042,489; 8,852,717; and 8,960,127. U.S. Pat. No. 7,249,570, for example, discloses a disposable, nonskid absorbent pad comprising a plurality of adhesive or frictional members fastened thereto that will prevent movement, in whole or in part, from the selective placement of the pad. Such adhesive or frictional members are disclosed in combination with peelable covers 30 that must be removed prior to use. Such peelable covers or strips are disadvantageous, however, because they can increase the overall manufacturing cost of an absorbent pad by as much as ten percent (10%) and create waste in the form of discarded peel-away material that is problematic to a user of such pads.

The small pieces of peel-away material are often difficult for users, and particularly elderly users, to pick up if they fall to the floor. Because they are relatively light-weight, they are easily blown or kicked under furniture and are then even more difficult to recover. Oftentimes, such peel-away material can adhere to surfaces of furniture, shoe soles, clothing or flooring once removed from the pad because of static electrical charges clinging to the peel-away surface or because a minor amount of adhesive remains on the peel-away material during the peeling process. Another disadvantage of peel-away strips or covers is the difficulty that is often encountered in separating the peel-away layer from the underlying adhesive layer, contributing to user frustration with the product and sometimes resulting in having all or a portion of the adhesive being inadvertently removed from the backsheet of the pad instead of just the peel-away portion.

### SUMMARY OF THE INVENTION

A selectively repositionable, nonskid, absorbent mat or pad (sometimes referred to as a “capillary action mat”) is disclosed here that desirably comprises a flexible polymeric backsheet substantially impermeable to moisture and other liquids when subjected to liquid levels, exposure times and drying intervals that are consistent with the intended use; at least one absorbent or capillary action wicking layer disposed above the backsheet that is desirably configured to receive and distribute moisture or other fluids deposited on the pad; and an optional cover layer disposed over the liquid-absorbing and distribution layer to protect the absorbent material from tearing, ripping, flaking, shredding or pulling during use. The absorbent layer is desirably smaller in length and width than the flexible polymeric backsheet so that the backsheet provides a generally rectangular margin around the absorbent layer that extends beyond the side and end boundaries of the absorbent layer.

The margin is satisfactorily configured to include at least one longitudinally extending fold line disposed inwardly of each outside edge of the backsheet, with each such fold line defining an inwardly or outwardly facing V-fold along each side of the mat into which a selectively releasable and reusable pressure-sensitive adhesive is sprayed during manufacture and then releasably sealed by folding two longitudinally extending, facing and opposed surface portions of the bottom surface of the backsheet. When configured in this manner, the finished mat or pad can be folded, packaged, shipped, stored, sold and used without the need for a release strip or cover of the type typically required for use with a pressure-sensitive adhesive.

At the time of use, the mat or pad is simply removed from its package, unfolded from its shipping configuration to its use configuration, and then the V-folds on each side are pulled open by grasping the opposed outside edges of the backsheet and pulling them laterally outward. This action opens the V-folds and causes the pressure-sensitive adhesive on each side of the bottom surface of the backsheet to be exposed. The mat can then be pressed downwardly into contact with an underlying substrate or other support surface and pressed against it to releasably secure the mat in a preferred location for use.

If desired, the mat can be relocated or repositioned at or near the same location by pulling upwardly on the edges of the backsheet until the tacky adhesive releases and then pressing the mat downwardly again in another desired position or location. For some uses, the mat can be reused in the same or a different location by allowing a major portion of the moisture or other liquid absorbed by the mat to evaporate. For other uses, the quantity or character of the absorbed liquid in the mat or pad may make disposal and replacement with another pad a more preferred option.

Those of skill in the art will appreciate upon reading this disclosure in relation to the accompanying drawings that the composition and internal configuration of the liquid absorbing portion of the subject mats can vary greatly, and can be formed or layered using, either alone or in various structural and compositional combinations, sprayed-on cellulosic fluff, layered cotton batting, superabsorbent polymers and gels, or other similarly effective materials known to be suitable for the intended use. While a primary application for the subject mats is the collection of fluids and materials generated by living organisms, they can also be used for the transference of materials or energy to undesirable areas.

A method of making the selectively positionable, liquid-absorbing mats of the invention capable of being sequentially repositioned by detaching and reattaching the backsheet to an underlying surface or substrate is desirably achieved by applying to predetermined surface portions on the bottom side of the backsheet a low-tack pressure sensitive material that exhibits continued tackiness following reuse. According to one satisfactory method of making the subject mats, a selectively releasable, pressure-sensitive adhesive is transferred to predetermined areas on the underside of the backsheet by a spray nozzle or wedge, wire rod coating, or by hand or use of a brush or other mechanical device while a web comprising a plurality of interconnected mats is moving rapidly past the applicators at speeds of up to 600 feet per minute or more. Folding guides and applicator rails are also desirably used to form the V-folds and position the brushes or spray heads, for example, during application of the adhesive.

Adhesive application methods can satisfactorily utilize single or multi-application points either parallel or perpendicular to the web direction. The spray angles are desirably adjustable to accommodate multiple fold sizes. The adhesive application sites can be disposed at or either upstream or downstream from where the folds are created. The pressure-sensitive materials used as the low-tack adhesives of the invention do not require a peel off strip, but are desirably selectively releasable when applied between facing surfaces of a folded polymeric backsheet. Where the intended use suggests the need for a higher level of adhesion, it can generally be achieved by increasing the surface area to which the adhesive is applied or by increasing the amount of low-tack pressure sensitive material that is applied inside the fold. Alternatively, in some cases it may be useful to reduce the holding force by inserting non-adhering articles between folded surfaces to which a tacky, pressure-sensitive adhesive has been applied prior to packaging.

The application of the low-tack pressure sensitive substances to positions disposed inwardly of the lateral edges along the longitudinally extending margins of the mats is generally preferred and will facilitate the release and recovery of an installed mat by allowing the user to grasp and fold or roll the outside edges inwardly. This methodology will also minimize migration of any collected material from the mat surface.

Use of the selectively repositionable, liquid-absorbing mats disclosed here will reduce the likelihood of slippage or accidental movement (or, in the case of animal use, even intentional movement) of the mat relative to an underlying surface or substrate upon which it is installed. The subject mats also eliminate the problematic use and expense of release strips or tabs that are otherwise typically required to cover a pressure-sensitive adhesive prior to installation and use of a moisture-absorbing pad. For many uses, the subject mats can be reused repeatedly during wet/dry cycles of about 24 hours.

Liquids that can be absorbed by the mats or pads of the invention include bodily fluids and other aqueous or non-aqueous liquid compositions. When intended for use with flammable liquids or in other applications where fire retardant properties are important, it should be understood that conventional, commercially available fire retardant components can be incorporated into the materials used to make the subject mats. Similarly, if the intended use will expose the mats and pads of the invention to contact with petroleum distillates, petrochemicals, organic solvents, or other substances that may degrade or impair their structural integrity, strength or functionality during a typical use cycle, such factors should be taken into consideration in selecting the materials used to produce such mats and pads.

### BRIEF DESCRIPTION OF THE DRAWINGS

The absorbent mats of the invention are further described and explained in relation to the following drawings wherein:

FIG. 1 is a plan view, partially broken away, of a web comprising plurality of absorbent mats of the invention connected in end-to-end relation and moving longitudinally from left to right, with dashed lines depicting the predetermined cut lines between adjacent mats;

FIG. 2 is an enlarged detail view of a portion of one of the absorbent mats of FIG. 1, with first and second longitudinal fold lines disposed along each side of the mat;

FIG. 3 is a transverse cross-sectional elevation view of an absorbent mat of the invention depicting the full width of the backsheet in relation to the width of the mat;

FIG. 4 is a transverse cross-sectional view of an absorbent mat of the invention as in FIG. 3 but having a longitudinally extending first fold line created by folding the outer edge of the backsheet upwardly and inwardly to create a longitudinally extending, inwardly opening V-fold on each side of the mat;

FIG. 5 is a transverse cross-sectional view of an absorbent mat of the invention as in FIG. 4 but having a longitudinally extending second fold line created by folding the inwardly lying outer edge of the backing sheet upwardly and outwardly to create a longitudinally extending, outwardly opening V-fold on each side of the mat;

FIG. 6 is a transverse cross-sectional view of an absorbent mat of the invention as in FIG. 5 wherein the longitudinally extending V-folds on each side of the absorbent mat as described in relation to FIGS. 4 and 5 are pressed downwardly so that the two V-folds on each side cooperate to form a compressed Z-fold in which facing and contacting bottom surface portions of the backsheet are held in place by a layer of selectively releasable, pressure-sensitive adhesive;

FIG. 7 is simplified diagrammatic view of one illustrative embodiment of a longitudinally extending portion of the backing sheet moving from left to right that is folded back over itself around a stationary folding guide that also dispenses a spray of pressure-sensitive adhesive into the fold, thereby enabling the facing surface portions to be pressed into facing and contacting releasable engagement with each other as shown in FIG. 6 after the backsheet passes the folding guide;

FIG. 8 is a cross-sectional elevation view taken transversely along line 8-8 of FIG. 7 showing an adhesive spray directed outwardly against the facing surfaces on each side of the fold;

FIG. 9 is simplified diagrammatic view of another illustrative embodiment of a longitudinally extending portion of the backing sheet moving from left to right that is folded back over itself around a stationary folding guide, together with a separate applicator guide spaced apart from the folding guide that dispenses a spray of pressure-sensitive adhesive into the fold, thereby enabling the facing surface portions to be pressed into facing and contacting releasable engagement with each other as shown in FIG. 6 after the backsheet passes the folding guide and applicator rail;

FIG. 10 is a cross-sectional elevation view taken transversely along line 10-10 of FIG. 9 showing an adhesive spray directly inwardly against the facing surfaces on each side of the fold;

FIG. 11 is simplified diagrammatic view of another illustrative embodiment of a longitudinally extending portion of the backsheet moving from left to right that is folded back over itself around a stationary folding guide, together with a separate applicator guide spaced apart from the folding guide that dispenses a spray of pressure-sensitive adhesive into the fold, thereby enabling the facing surface portions to be pressed into facing and contacting releasable engagement with each other as shown in FIG. 6 after the backsheet passes the folding guide and applicator rail;

FIG. 12 is a cross-sectional elevation view taken transversely along line 12-12 of FIG. 11 showing an adhesive spray directed downwardly against the surface on one side of the fold;

FIG. 13 is simplified diagrammatic view of another illustrative embodiment of a longitudinally extending portion of the backsheet moving from left to right that is folded back over itself around a stationary folding guide, together with a separate applicator guide spaced apart from the folding guide that dispenses a spray of pressure-sensitive adhesive into the fold, thereby enabling the facing surface portions to be pressed into facing and contacting releasable engagement with each other as shown in FIG. 6 after the backsheet passes the folding guide and applicator rail;

FIG. 14 is a cross-sectional elevation view taken transversely along line 14-14 of FIG. 13 showing an adhesive spray directed upwardly against the surface on one side of the fold;

FIG. 15 is a cross-sectional view of an absorbent pad as in FIG. 6, with the Z-fold being pulled open from the outer edges to expand the Z-folds and expose the releasable pressure-sensitive adhesive disposed inside the outwardly opening V-fold on each side of the absorbent mat prior to use in sticking the outer portions of the bottom surface of the backsheet to an underlying support surface;

FIG. 16 is a cross-sectional view of the absorbent mat of FIG. 15 with the Z-folds fully extended on both sides of the absorbent mat and with the pressure-sensitive adhesive being pressed downwardly onto an underlying support surface to hold the mat in place;

FIG. 17 is an alternate embodiment of the absorbent mat of the invention in which the outside edges of the backsheet are folded downward around a longitudinally extending folding guide and into facing relation to the bottom surface of the backsheet to form a single, longitudinally extending, inwardly opening V-fold on each side of the backsheet into which selectively releasable, pressure-sensitive adhesive is sprayed;

FIG. 18 shows the absorbent mat of FIG. 17 with the resultant fold being pressed together and closed against the bottom of the backsheet on each side edge of the pad for packaging, shipping and storage, with arrows 130, 132 indicating the direct in which the mat edges are unfolded to the position shown in FIG. 19; and

FIG. 19 shows the mat of FIG. 18 with the folds on each side edge being reopened prior to use by grasping the outside edges of the backing sheet and pulling them laterally outward to expose the pressure-sensitive adhesive for use in releasably attaching the bottom surface of the pad to an underlying support surface.

When examining the accompanying drawings, it should be appreciated that the drawing figures are created for illustrative purposes and are simplified and not drawn to scale, so that relative sizes and proportions of various components and structural features of the invention can vary substantially from those depicted while still remaining within the scope of the invention as defined by the appended claims.

### DESCRIPTION OF THE PREFERRED EMBODIMENTS

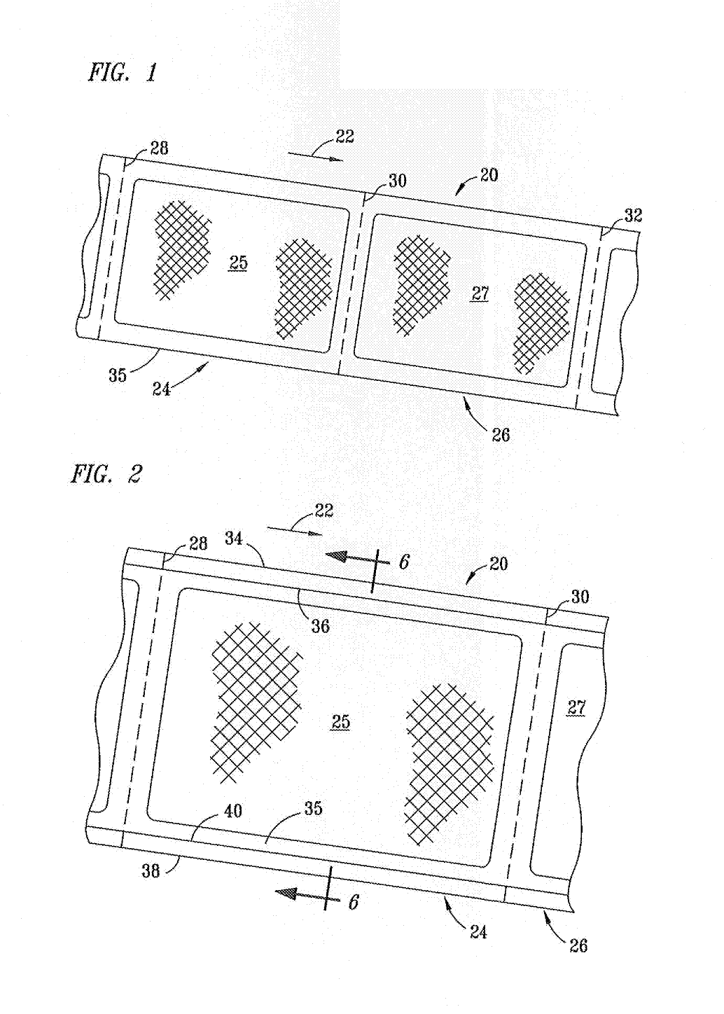

FIGS. 1 and 2 depict a continuous web 20 comprising a plurality of mats 24, 26 disposed in end-to-end relation and moving from left to right as indicated by arrow 22. Dashed cut lines 28, 30, 32 are depicted between successive pairs of mats, with cut line 30 being disposed between mats 25, 27. Cut lines 28, 30, 32 can be real or virtual, depending upon the method used to separate the pads prior to packaging. Such cut lines can be scored to facilitate subsequent mechanical separation, or separation can be achieved using a rotating blade, hot wire, or other conventionally known means. Web 20 desirably moves at a relatively high rate of speed, such as 600 feet per minute or more, and can be supported on or between moving belts, rollers, or the like (not shown) as needed to perform the various operational steps needed to produce such mats 24, 26.

Each mat 24, 26 further comprises a liquid-absorbing portion 25, 27 that is supported on and attached to backsheet 35. Backsheet 35 is desirably a thin, flexible, liquid-impermeable polymeric sheet or film made from an extrudable polymer such as polyethylene or polypropylene, or from another polymer, copolymer or terpolymer chosen for making mats intended for particular uses or applications. Liquid-absorbing portion 25, 27 can comprise one or more layers of the same or different materials selected for their collective ability to receive liquid deposited on the exposed surface during use and then retain the liquid inside mat 24, 26 until it dries or until the mat is removed. Depending upon the structure and composition of liquid-absorbing portion 25, 27 of mats 24, 26, liquid can be captured inside a hydrophilic gel, wicked away from the surface toward backsheet 35, or otherwise channeled and distributed throughout the mats. Liquid-absorbing portion 25, 27 can be applied to backsheet 35 by known deposition or buildup methods, and as shown in FIGS. 1-2, can be covered by a woven or porous protective layer that will permit the passage of liquids into the absorbent material but will also protect the absorbent layer from being ripped or torn, such as by animal claws, during use.

Referring to FIG. 2, mat 24 disposed between cut lines 28, 30 of web 20 desirably further comprises longitudinally extending lateral side edges 34, 38 of backsheet 35, and longitudinally extending fold lines 36, 40. Fold lines 36, 40 are disposed inwardly of side edges 34, 38 and between side edges 34, 38 and liquid absorbing portion 25 of mat 25. Referring to FIG. 6, a cross-sectional elevation view is depicted that is taken along line 6-6 of FIG. 2. FIG. 6 better illustrates that mat 24 desirably comprises liquid-absorbing layer 25 centrally disposed upon an upwardly facing surface of polymeric backsheet 35. Liquid-absorbing layer 25 satisfactorily further comprises one or more absorbent materials 44 selected from cellulosic fluff, super-absorbing polymer, or other known fibrous or granular components or materials, used alone or in combination, that are generally known to be effective absorbents of liquids of the type intended for a particular intended application for mat 24. Protective cover 42 is desirably a thin netting or porous material as previously discussed that will readily permit the passage of liquids into absorbent materials 44 while holding absorbent materials 44 in place on backsheet 35. Protective cover 42 is desirably held in place over absorbent materials 44 by an adhesive material (not shown) that is sprayed or otherwise applied to the upwardly facing surface of backsheet 35.

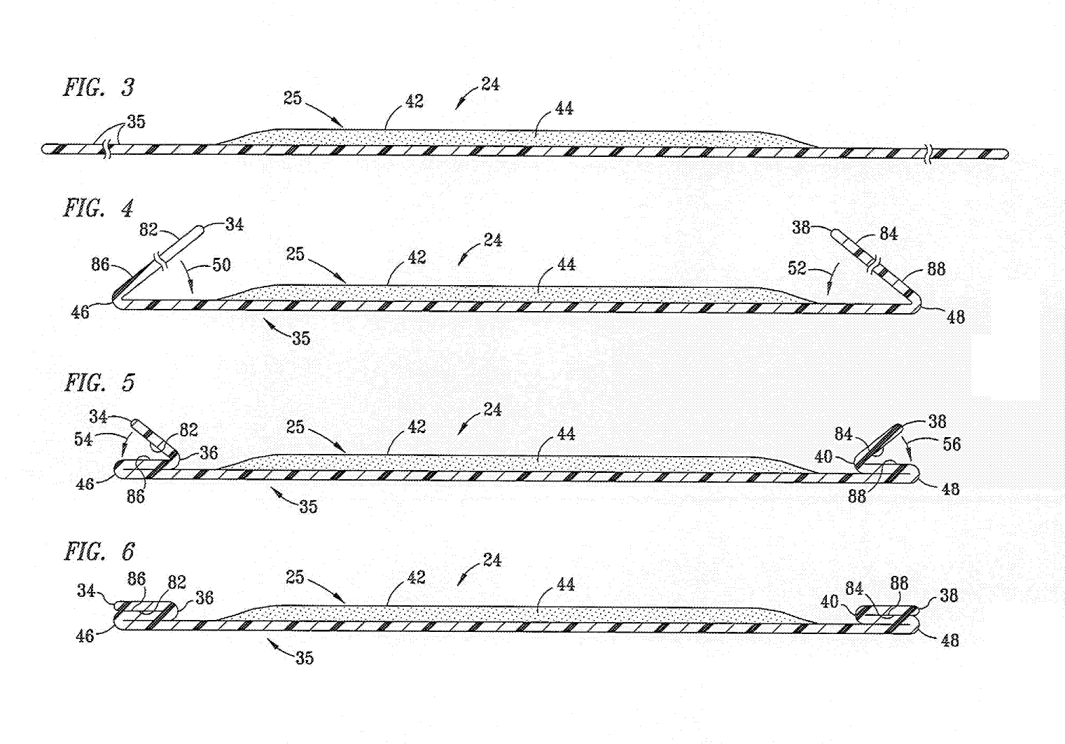

Referring again to FIG. 6, a Z-fold is depicted on each of the laterally disposed sides of backsheet 35 beyond the side edges of liquid-absorbing layer 25. As depicted, each Z-fold is formed on the upwardly facing surface of backsheet 35. The detailed structure and method of forming each Z-fold is further described in relation to FIGS. 3-5 and 15-16 of the drawings.

Referring first to FIG. 3, mat 24 as previously described is depicted with the full width of backsheet 35 shown laterally in one plane, with outside edges of backsheet 35 extending well beyond the side edges of liquid-absorbing layer 25. In FIG. 4, the opposed, laterally extending side edges 34, 38 of backsheet 35 are folded upwardly and inwardly toward the upwardly facing surface of backsheet 35 as indicated by arrows 50, 52, respectively, causing the upwardly facing surface of backsheet 35 to be folded over itself and creating a first longitudinally extending fold line 46, 48 on each side of mat 24. In FIG. 5, laterally extending side edges 34, 38 of backsheet 35 are refolded back to the outside of mat 24 as indicated by arrows 54, 56, thereby creating a V-fold that opens outwardly on each lateral side of mat 24 around second longitudinally extending fold lines 36, 40, respectively. Taken in combination, the initial folds made to create fold lines 46, 48, together with the outwardly opening V-folds made by refolding side edges 34, 38 outwardly to create second fold lines 36, 40, a Z-fold is thereby created on the upwardly facing side of backsheet 35. Upon completion of the second (reverse) fold, mat 24 has the configuration shown in FIG. 6.

In accordance with the present invention, with reference to FIG. 5, a selectively releasable pressure-sensitive adhesive is desirably applied at least between facing opposed surface portions 82 and 86 (which are also part of the downwardly facing surface of backsheet 35 as depicted in FIG. 3) before completing the fold to the position shown in FIG. 6. The presence of pressure-sensitive adhesive inside the V-folds opening outwardly around second fold lines 36, 40 is seen in FIG. 15, as discussed below in relation to subsequent opening of that fold prior to installation of mat 24.

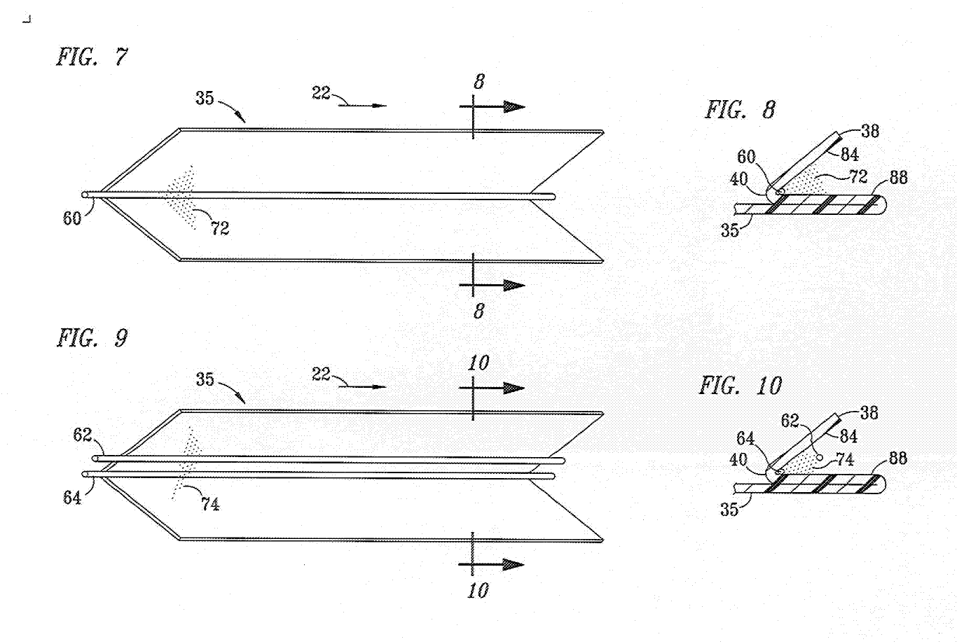

A satisfactory method for depositing a selectively releasable pressure-sensitive adhesive inside a V-fold in backsheet 35 is further described in relation to the simplified diagrammatic representations depicted in FIGS. 7-14. It should be understood that the portion of backsheet 35 depicted in FIGS. 7-14 is a longitudinally extending segment taken from the right side of the full-width web of backsheet 35 and is moving continuously from left to right as indicated by arrows 22, with the right edge 38 of backsheet 35 refolded outwardly to create second longitudinally extending fold line 40.

FIGS. 7 and 8 disclose a method of the invention whereby backsheet 35 is folded around longitudinally extending folding guide 60 that remains stationary relative to moving backsheet 35 and also comprises a fluid flow channel and nozzle from which a selectively releasable pressure-sensitive adhesive is sprayed outwardly onto opposed surface portions 84, 88 that are also shown in FIGS. 4-6. A satisfactory spray pattern 72 is shown in FIGS. 7 and 8, although other similarly effective spray patterns or non-spraying methods of depositing pressure-sensitive adhesive inside the V-fold can also be used within the scope of the invention. It is apparent from FIGS. 4-6 and 8 that surface portions 84, 88 are both part of the underside (downwardly facing surface) of backsheet 35.

FIGS. 9 and 10 disclose another embodiment of a satisfactory method of the invention whereby backsheet 35 is folded around longitudinally extending, stationary (although adjustable) folding guide 64 to form longitudinally extending fold line 40 as previously described. In this embodiment, however, a separate applicator rail 62 is provided that is disposed in spaced-apart relation to folding guide 64 and is also stationary relative to the moving backsheet 35 and comprises a fluid flow channel and nozzle from which a selectively releasable pressure-sensitive adhesive is sprayed inwardly onto surface portions 84, 88 of backsheet 35. A satisfactory spray pattern 74 is shown in FIGS. 9 and 10, although other similarly effective spray patterns or non-spraying methods of depositing pressure-sensitive adhesive inside the V-fold can also be used within the scope of the invention.

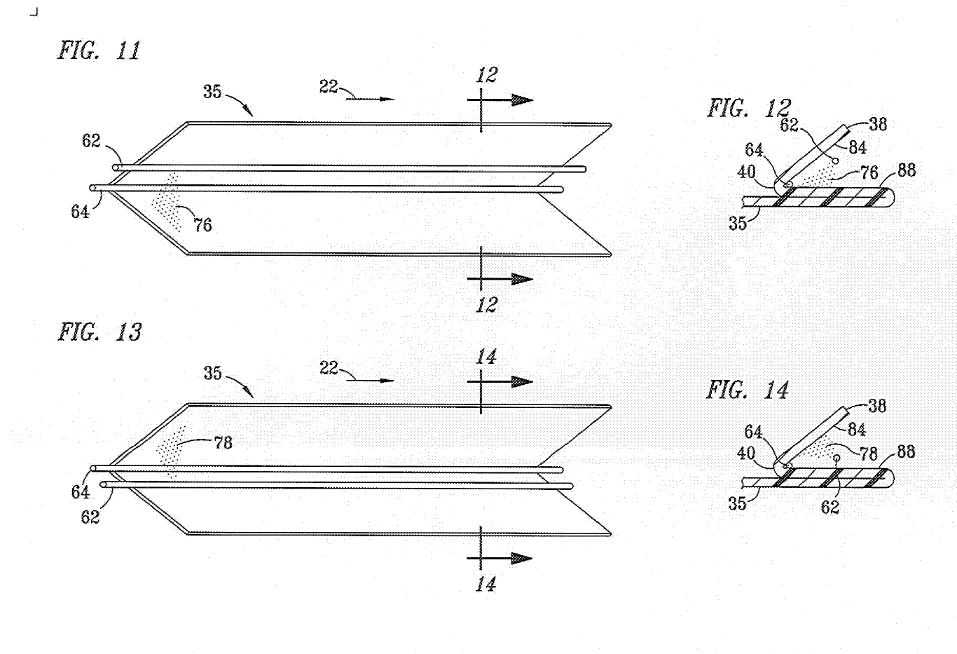

FIGS. 11 and 12 disclose another embodiment of a satisfactory method of the invention whereby backsheet 35 is folded around longitudinally extending, stationary (although adjustable) folding guide 64 to form longitudinally extending fold line 40 as previously described. In this embodiment, however, a separate applicator rail 62 is provided that is disposed in spaced-apart relation to folding guide 64 and is also stationary relative to the moving backsheet 35 and comprises a fluid flow channel and nozzle from which a selectively releasable pressure-sensitive adhesive is sprayed downwardly onto surface portion 88 of backsheet 35. A satisfactory spray pattern 76 is shown in FIGS. 11 and 12, although other similarly effective spray patterns or non-spraying methods of depositing pressure-sensitive adhesive inside the V-fold can also be used within the scope of the invention.

FIGS. 13 and 14 disclose another embodiment of a satisfactory method of the invention whereby backsheet 35 is folded around longitudinally extending, stationary (although adjustable) folding guide 64 to form longitudinally extending fold line 40 as previously described. In this embodiment, however, a separate applicator rail 62 is provided that is disposed in spaced-apart relation to folding guide 64 and is also stationary relative to the moving backsheet 35 and comprises a fluid flow channel and nozzle from which a selectively releasable pressure-sensitive adhesive is sprayed upwardly onto surface portion 84 of backsheet 35. A satisfactory spray pattern 78 is shown in FIGS. 13 and 14, although other similarly effective spray patterns or non-spraying methods of depositing pressure-sensitive adhesive inside the V-fold can also be used within the scope of the invention.

Referring again to FIG. 6, because the selectively releasable, pressure-sensitive adhesive is disposed inside a V-fold of mat 24 of the invention, no pressure-sensitive adhesive is exposed, and no separate release strip or cover member is needed to protect the adhesive during the remainder of the manufacturing and packaging process during which web 20 (FIGS. 1-2) is separated into individual mats that are folded and packaged for shipment, storage or distribution, and sale prior to being unpackaged for use by a consumer.

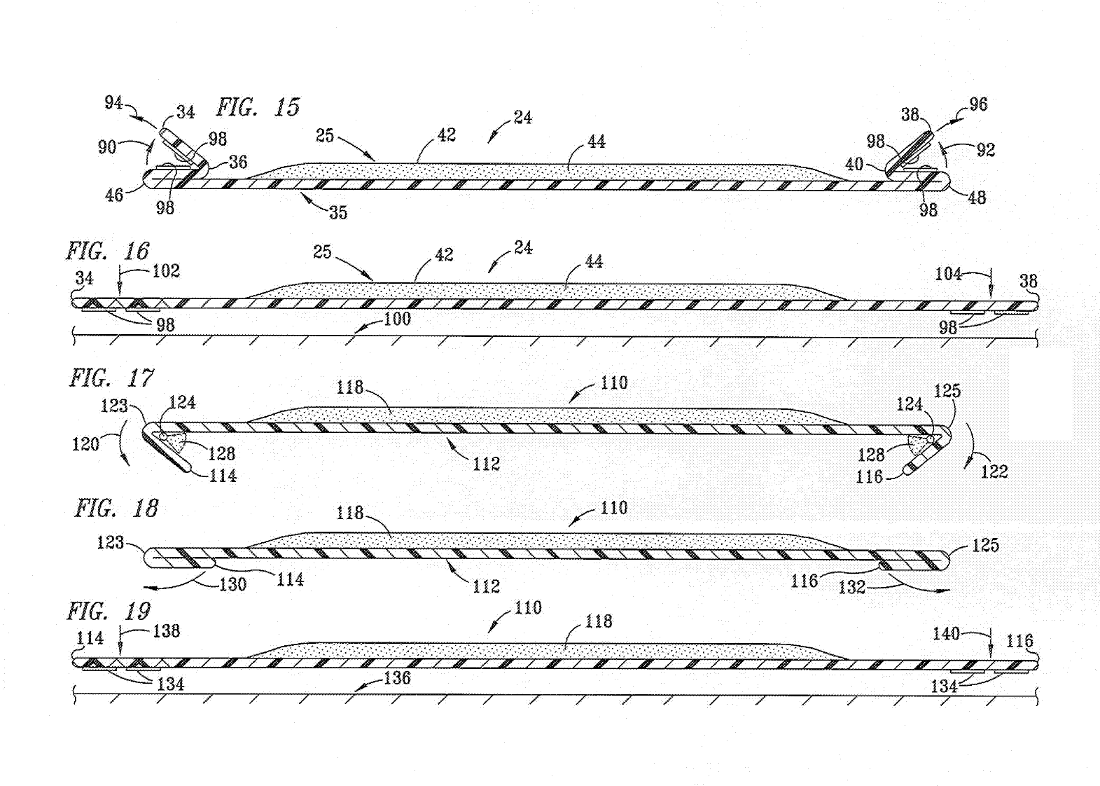

Referring next to FIGS. 15-16, when mat 24 is ready for use, the V-folds on each side of mat 24 are desirably opened by pulling edges 34, 38 of backsheet 35 upwardly and outwardly as indicated by arrows 90, 92 and 94, 96, respectively, to open the outwardly facing V-folds. Although not clearly depicted in the drawings, side edges 34, 38 will desirably overhang first longitudinally extending fold lines 46, 48, respectively, so that side edges 34, 38 can be readily grasped by the user to overpressure the adhesion and cohesion of pressure-sensitive adhesive 98 to open the folds. No other peeling or removal of release strips or covers is required as is the case with other conventional mats or pads. Once the folds are pulled fully open, as shown in FIG. 16, pressure-sensitive adhesive 98 faces downwardly on the underside of mat 24, permitting mat 24 to be releasably secured in a non-skid position to support surface 100. Mat 24 can then remain in place until such time as repositioning or removal for disposal is required.

When repositioning or removal of mat 24 is required, it is again helpful if a graspable portion of the outside edges 34, 38 of backsheet 35 is provided for use in lifting mat 24 away from support surface 100 to pull the pressure-sensitive adhesive 98 away from the support surface. This is most easily done by lifting mat 24 from one side at a time and rolling or folding the respective side edge inwardly toward the center of mat 24 so that any debris lying on the surface of mat 24 is captured inside the roll or fold.

Another embodiment of the invention is disclosed in relation to FIGS. 17-19. In this embodiment, Mat 110 comprises a liquid-absorbing layer 118 disposed on backsheet 112 having oppositely disposed, outside edges 114, 116. A pressure-sensitive adhesive as previously described is deposited inside a single V-fold made around oppositely disposed, longitudinally extending fold lines 123, 125 by folding side edges 114, 116 downwardly as indicated by arrows 120, 122, respectively, to form a single, inwardly facing V-fold on the underside of backsheet 112 as shown in FIG. 18. Referring again to FIG. 17, a longitudinally extending folding guide 124 is provided that also comprises a fluid flow path through which a spray 128 of pressure-sensitive adhesive is applied to the facing surfaces inside the fold. Following packaging, shipping, storage and sale, mat 110 is desirably removed from its packaging and unfolded to the position shown in FIG. 18, after which a user desirably grasps outside edges 114, 116 of backsheet 112 and opens the V-fold on each side of the downwardly facing surface of backsheet 112 as indicated by arrows 130, 132 to expand the folds to the use position as seen in FIG. 19. Referring to FIG. 19, mat 110 is desirably installed by pressing downwardly on downwardly facing pressure-sensitive adhesive strips 135 as indicated by arrows 138, 140 to releasably secure mat 110 to support surface 136 pending repositioning or disposal as previously described above.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventors and/or Applicant are legally entitled.

What is claimed is:

1. A selectively repositionable mat having a liquid-absorbing layer backed by a liquid-impermeable backsheet having a top side, bottom side, and peripheral margins including oppositely disposed, laterally extending side margins each comprising a longitudinally extending V-fold comprising a pressure-sensitive adhesive applied between two opposed surface portions of the bottom side.

2. The selectively repositionable mat of claim 1 wherein the V-fold opens to the outside and is configured as part of a Z-fold disposed on the top side the backsheet.

3. The selectively repositionable mat of claim 1 wherein the V-fold or opens to the inside and is configured as a single fold disposed below the bottom side of the backsheet.

4. The selectively repositionable mat of claim 1 wherein the backsheet has two oppositely disposed, longitudinally extending side edges and wherein the pressure-sensitive adhesive disposed inside the V-fold is selectively releasable by grasping and pulling the opposed side edges laterally prior to use of the mat.

5. The selectively repositionable mat of claim 1 wherein the pressure-sensitive adhesive exhibits tackiness sufficient to hold the mat in a substantially fixed position relative to an underlying surface or substrate.

6. The selectively repositionable mat of claim 1 wherein the two opposed surface portions of the bottom side are pressured into facing contact with the pressure-sensitive adhesive disposed between them and are releasably held in that position prior to use.

7. The selectively repositionable mat of claim 1 wherein the liquid-absorbing layer and backsheet further comprise fire retardant compositions.

8. The selectively repositionable mat of claim 1 further comprising a cover layer disposed over the liquid-absorbent layer, wherein the cover layer protects and permits the passage of liquid into the liquid-absorbent layer.

9. The selectively repositionable mat of claim 1 wherein the liquid absorbent layer and backsheet are made of materials resistant to degradation when contacted by an absorbed liquid.

10. A method for making a selectively repositionable mat having a liquid-absorbing layer backed by a liquid-impermeable backsheet having a top side, bottom side, and peripheral margins including oppositely disposed, laterally extending side margins each comprising a longitudinally extending V-fold comprising a pressure-sensitive adhesive applied between two opposed surface portions of the bottom side,
wherein the V-fold is formed in a high-speed web comprising a plurality of the subject mats joined in end-to-end relation by passing the laterally extending side margins of the backsheet over and around a longitudinally extending folding guide; and
wherein the pressure-sensitive adhesive is applied inside the V-fold formed in the moving web.

11. The method of claim 10 wherein the pressure-sensitive adhesive is sprayed through a nozzle disposed in fluid communication with a longitudinally extending applicator rail.

12. The method of claim 10 wherein the pressure-sensitive adhesive is sprayed through a nozzle disposed in fluid communication with the folding guide.

13. The method of claim 11 wherein the folding guide and the applicator rail are substantially parallel.

14. The method of claim 10 wherein the V-fold opens outwardly as the pressure-sensitive adhesive is applied.

15. The method of claim 10 wherein the V-fold opens inwardly as the pressure sensitive adhesive is applied.

16. The method of claim 10 wherein the pressure-sensitive adhesive is applied to a surface inside the V-fold.

17. The method of claim 14 wherein the pressure-sensitive adhesive is applied to a plurality of surfaces disposed inside the V-fold.
